(19) United States
(12) Patent Application Publication
(10) Pub. No.: US 2008/0313070 A1
(43) Pub. Date: Dec. 18, 2008

(54) SYSTEM, METHOD AND APPARATUS FOR CONSUMER PURCHASE AND FUTURE DISTRIBUTED DELIVERY OF COMMODITY AT PREDETERMINED PRICES

(75) Inventors: Robert M. Fell, Summerland, CA (US); Scott Painter, Bel Air, CA (US); Michael R. Bonsignore, Seattle, WA (US); Brian P. Reed, Southlake, TX (US); Gary A. Magnuson, Corpus Christi, TX (US); Thomas D. Gros, Houston, TX (US)

Correspondence Address: SPRINKLE IP LAW GROUP, 1301 W. 25TH STREET, SUITE 408, AUSTIN, TX, 78705, US

(73) Assignee: Pricelock, Inc., Irving, TX (US)

(21) Appl. No.: 12/030,012

(22) Filed: Feb. 12, 2008

Related U.S. Application Data
(60) Provisional application No. 60/900,929, filed on Feb. 12, 2007.
(60) Provisional application No. 60/966,574, filed on Aug. 29, 2007.

(51) Int. Cl. G06Q 40/00

(52) U.S. Cl. 705/37

(57) ABSTRACT

Embodiments disclosed herein provide a unique methodology as well as the overall architecture necessary to implement the methodology that can enable an entity to create and provide a consumer price protection product under the Forward Contract Exception of the Commodity Exchange Act. Even consumers who do not meet commodity-related regulation requirements such as the Eligible Contract Participant regulatory requirements may purchase such a consumer price protection product or a variation thereof to reduce or cancel out the risk or at least reduce the unpredictability in purchasing commodities such as motor fuels.

### CROSS-REFERENCE TO RELATED APPLICATIONS

This application claims priority from Provisional Patent Applications No. 60/900,929, filed Feb. 12, 2007, entitled “METHOD AND SYSTEM FOR PROVIDING PRICE PROTECTION FOR COMMODITY PURCHASING THROUGH CONSUMER CONTRACTS” and No. 60/966,574, filed Aug. 29, 2007, entitled “SYSTEM, METHOD AND APPARATUS FOR CONSUMER PURCHASE AND FUTURE DISTRIBUTED DELIVERY OF COMMODITY AT PREDETERMINED PRICES,” the entire contents of which are hereby expressly incorporated herein by reference for all purposes. This application relates to U.S. patent application Ser. No. 11/705,571, filed Feb. 12, 2007, entitled “METHOD AND SYSTEM FOR PROVIDING PRICE PROTECTION FOR COMMODITY PURCHASING THROUGH PRICE PROTECTION CONTRACTS” and Provisional Patent Application No. 60/922,427, filed Apr. 9, 2007, entitled “SYSTEM AND METHOD FOR INDEX BASED SETTLEMENT UNDER PRICE PROTECTION,” which are incorporated herein by reference as if set forth in full.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### FIELD OF THE INVENTION

The present invention relates generally to price protection on commodity purchases. More particularly, the present invention relates to a system and method for providing retail consumers ways to obtain price protection against variability on commodity prices. Even more particularly, embodiments disclosed herein provide the know-how for the creation of a consumer product which is in compliance with current commodity-related regulatory requirements and which allows a retail consumer to obtain price protection against adverse fluctuations in the retail price of a commodity.

### BACKGROUND OF THE RELATED ART

Making a decision to purchase a commodity can be a very difficult process, particularly if that commodity tends to fluctuate in an unpredictable manner. For example, as the price of oil continues to fluctuate globally and fluidly, fuel prices at the pump can change from location to location on a daily or even hourly basis. In such a volatile market, it can be extremely difficult for retail consumers to make sound decisions on where, how much, when, or even what fuel grade to buy and the terms on which to buy the commodity.

For commercial entities and large users of energy commodities, in some cases, they may be able to negotiate the price of a commodity by way of a forward contract. A forward contract is an agreement between two parties to buy or sell an asset, which can be of any kind, at a pre-agreed future point in time. It is used to control and hedge risk and must include the elements of price, quality, time, and location. In finance, a hedge is an investment that is taken out specifically to reduce or cancel out the risk in another investment. For example, forward contracts on U.S. dollars may be used to control and hedge currency exposure risk and forward contracts on oil may be used to control commodity prices. Under a forward contract, a purchaser has the right and the obligation to take physical, fixed forward delivery at the pre-agreed further point in time. As a specific example, a forward contract on gasoline may specify that a purchaser can take physical delivery of a million gallons of gasoline in six months on a particular day. So, the purchaser basically buys forward and takes physical delivery of a million gallons of gasoline in six months on that day.

A standardized forward contract that is traded on an exchange is called a futures contract. A futures contract gives a purchaser the obligation to buy, which differs from an options contract, which gives the purchaser the right, but not the obligation to buy. Within the context of this disclosure, an option refers to a financial instrument that conveys the right, but not the obligation, to engage in a future transaction on a good or product. Thus, purchasing an option gives the purchaser the right to buy or sell a good or product at a specified price at some time on or before expiration. It is the purchaser's choice to exercise the option, at which time, the other party must fulfill the terms of the contract and the trade will be at the strike price, also referred to as the exercise price, regardless of the spot price (i.e., the market price) of the good or product at that time.

All futures transactions in the United States are regulated by the Commodity Futures Trading Commission (CFTC), an independent agency of the United States Government. These may be referred to as commodity-type regulatory requirements, which are separate and independent from accounting-type regulatory requirements. Commercial and industrial consumers generally are subject to commodity-related regulations as well as accounting rules such as those established by the Financial Accounting Standards Board (FASB). The FASB is the designated organization in the private sector for establishing standards of financial accounting and reporting. Standards established by the FASB are officially recognized as authoritative by the Securities and Exchange Commission (SEC). Certain retail consumers may also need to comply with accounting-type regulatory requirements.

Retail consumers generally do not participate in futures transactions as very few individuals may meet the commodity-type regulatory requirements. Under the Commodity Futures Modernization Act of 2000 (CFMA), if a Futures Commission Merchant (FCM) is an individual, the FCM is not considered an Eligible Contract Participant (ECP) unless a) he or she is a floor trader or floor broker regulated by the Commodity Exchange Act (CEA) in connection with transactions that take place on or through a registered entity or exempt board of trade (or an affiliate thereof) on which the FCM regularly trades; or b) he or she has a total assets in excess of $10,000,000; or $5,000,000 and enters into the agreement, contract or transaction in order to manage the risks associated with an asset the FCM owns, or a liability that he or she incurred or is reasonably likely to own or incur.

The aforementioned regulatory requirements generally limit the ability of average consumers, including retail consumers and small business operations unable to meet the ECP regulatory requirements, to trade futures and reduce or cancel out the risk associated with purchasing commodities such as motor fuels.

### SUMMARY OF THE INVENTION

Within this disclosure, the term “consumers” is intended to include individuals and small entities or business operations which are not qualified to participate in futures transactions due to some regulatory requirements. Embodiments disclosed herein provide viable solutions in providing price protection to such consumers against unpredictable commodity prices. In some embodiments, this price protection can be realized in a retail product that is both consumer friendly and in compliant with current regulatory requirements.

There are many types of regulatory requirements. Some embodiments of a retail consumer price protection product disclosed herein may comply with commodity-related regulatory requirements. Some embodiments of a retail consumer price protection product disclosed herein may comply with accounting-related regulatory requirements. Some embodiments of a retail consumer price protection product disclosed herein may comply with commodity-related as well as accounting-related regulatory requirements. Examples of commodity-related regulations include the Commodities Exchange Act (CEA), which is enforced by the Commodities Futures Trading Commission (CFTC). Examples of accounting-related regulations include standards established by the Financial Accounting Standards Board (FASB), which include Statement of Financial Accounting Standards Number 133 Accounting for Derivatives and Hedge Accounting as amended (FAS 133).

Embodiments disclosed herein provide a unique methodology as well as the overall architecture necessary to implement the methodology, including, but not limited to, computer software, hardware, systems, networks, etc. that can enable an entity to create and provide price protection products for retail consumers under the Forward Contract Exception of the Commodity Exchange Act. Even retail consumers who do not meet the ECP regulatory requirements may purchase such a consumer price protection product or a variation thereof to reduce or cancel out the risk or at least reduce the unpredictability in purchasing commodities such as fuel. In addition to meeting commodity-related regulatory requirements, one advantage is that such a consumer price protection product would also enable consumers who are subject to the specific FAS 133 requirements to be compliant with the applicable accounting rules.

This and other aspects and advantages will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of the disclosure, and the disclosure includes all such substitutions, modifications, additions or rearrangements.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 depicts a block diagram of one embodiment of a design architecture for providing a consumer price protection product that meets the Eligible Contract Participant regulatory requirements;

FIG. 2 depicts a block diagram of one embodiment of a system architecture for providing a Web-based consumer price protection product over a network; and

FIG. 3 is a screenshot of one embodiment of a user interface of a Web-based application through which a consumer price protection product that meets the Eligible Contract Participant regulatory requirements may be purchased over the Internet.

### DETAILED DESCRIPTION

The invention and the various features and advantageous details thereof are explained more fully with reference to the non-limiting embodiments that are illustrated in the accompanying drawings and detailed in the following description. Descriptions of well known starting materials, processing techniques, components and equipment are omitted so as not to unnecessarily obscure the disclosure in detail. Skilled artisans should understand, however, that the detailed description and the specific examples, while disclosing preferred embodiments, are given by way of illustration only and not by way of limitation. Various substitutions, modifications, additions or rearrangements within the scope of the underlying inventive concept(s) will become apparent to those skilled in the art after reading this disclosure.

Before discussing specific embodiments, an exemplary hardware architecture for implementing embodiments of the present invention will now be described. Specifically, one embodiment of the present invention can include a computer communicatively coupled to a network (e.g., the Internet). As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (e.g., mouse, trackball, stylist, etc.), or the like. In embodiments of the invention, the computer has access to at least one database over the network.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (e.g., a HD). Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of complied C++, Java, HTML, or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. In some embodiments, a product, process, article, or apparatus that comprises a list of elements is not necessarily limited only those elements but may include other elements not expressly listed or inherent to such product, process, article, or apparatus. Further, unless expressly stated to the contrary, “or” refers to an inclusive or and not to an exclusive or. In some embodiments, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment.”

Within this disclosure, the term “commodity” refers to an article of commerce—an item that can be bought and sold freely on a market. It may be a product which trades on a commodity exchange or spot market and which may fall into one of several categories, including energy, food, grains, and metals. Currently, commodities that can be traded on a commodity exchange include, but are not limited to, crude oil, light crude oil, natural gas, heating oil, gasoline, propane, ethanol, electricity, uranium, lean hogs, pork bellies, live cattle, feeder cattle, wheat, corn, soybeans, oats, rice, cocoa, coffee, cotton, sugar, gold, silver, platinum, copper, lead, zinc, tin, aluminum, titanium, nickel, steel, rubber, wool, polypropylene, and so on. Note that a commodity can refer to tangible things as well as more ephemeral products. Foreign currencies and financial indexes are examples of the latter. For example, positions in the Goldman Sachs Commodity Index (GSCI) and the Reuters Jefferies Consumer Research Board Index (RJCRB Index) can be traded as a commodity. What matters is that something be exchanged for the thing. New York Mercantile Exchange (NYMEX) and Chicago Mercantile Exchange (CME) are examples of a commodity exchange. Other commodities exchanges also exist and are known to those skilled in the art.

In a simplified sense, commodities are goods or products with relative homogeneousness that have value and that are produced in large quantities by many different producers; the goods or products from each different producer are considered equivalent. Commoditization occurs as a goods or products market loses differentiation across its supply base. As such, items that used to carry premium margins for market participants have become commodities, of which crude oil is an example. However, a commodity generally has a definable quality or meets a standard so that all parties trading in the market will know what is being traded. In the case of crude oil, each of the hundreds of grades of fuel oil may be defined. For example, West Texas Intermediate (WTI), North Sea Brent Crude, etc. refer to grades of crude oil that meet selected standards such as sulfur content, specific gravity, etc., so that all parties involved in trading crude oil know the qualities of the crude oil being traded. Motor fuels such as gasoline represent examples of energy-related commodities that may meet standardized definitions. Thus, gasoline with an octane grade of 87 may be a commodity and gasoline with an octane grade of 93 may also be a commodity, and they may demand different prices because the two are not identical—even though they may be related. Those skilled in the art will appreciate that other commodities may have other ways to define a quality. Other energy-related commodities that may have a definable quality or that meet a standard include, but are not limited to, diesel fuel, heating oils, aviation fuel, and emission credits. Diesel fuels may generally be classified according to seven grades based in part on sulfur content, emission credits may be classified based on sulfur or carbon content, etc.

Historically, risk is the reason exchange trading of commodities began. For example, because a farmer does not know what the selling price will be for his crop, he risks the margin between the cost of producing the crop and the price he achieves in the market. In some cases, investors can buy or sell commodities in bulk through futures contracts. The price of a commodity is subject to supply and demand.

A commodity may refer to a retail commodity that can be purchased by a consuming public and not necessarily the wholesale market only. One skilled in the art will recognize that embodiments disclosed herein may provide means and mechanisms through which commodities that currently can only be traded on the wholesale level may be made available to retail level for retail consumption by the public. One way to achieve this is to bring technologies that were once the private reserves of the major trading houses and global energy firms down to the consumer level and provide tools that are applicable and useful to the retail consumer so they can mitigate and/or manage their measurable risks involved in buying/selling their commodities. One example of an energy related retail commodity is motor fuels, which may include various grades of gasoline. For example, motor fuels may include 87 octane grade gasoline, 93 octane grade gasoline, etc as well as various grades of diesel fuels. Other examples of an energy related retail commodity could be jet fuel, heating oils, electricity or emission credits such as carbon offsets. Other retail commodities are possible and/or anticipated.

While a retail commodity and a wholesale commodity may refer to the same underlying good, they are associated with risks that can be measured and handled differently. One reason is that, while wholesale commodities generally involve sales of large quantities, retail commodities may involve much smaller transaction volumes and relate much more closely to how and where a good is consumed. The risks associated with a retail commodity therefore may be affected by local supply and demand and perhaps different factors. Within the context of this disclosure, there is a definable relationship between a retail commodity and the exposure of risks to the consumer. This retail level of the exposure of risks may correlate to the size and the specificity of the transaction in which the retail commodity is traded. Other factors may include the granularity of the geographic market where the transaction takes place, and so on. For example, the demand for heating oil No. 2 in January may be significantly different in the Boston market than in the Miami market.

Reference is now made in detail to the exemplary embodiments, examples of which are illustrated in the accompanying drawings. Wherever possible, the same reference numbers will be used throughout the drawings to refer to the same or like parts (elements).

Embodiments disclosed herein provide a consumer price protection product for protecting consumers from unpredictable retail prices of a commodity. To make such a price protection product available to consumers and viable to a provider thereof several criteria should be considered, including, but not limited to, pricing from a financial partner, if any; pricing to the customer; marketability of the consumer price protection product; balanced value for the customer and the provider; transaction systems and data network constraints; and compliance to the regulatory requirements.

Pricing a consumer price protection product that meets the Eligible Contract Participant regulatory requirements can be an extremely difficult task, particularly in cases where the price of the subject commodity itself may fluctuate greatly in an unpredictable manner. Pricing factors may include, but not limited to, whether a financial partner is involved in offloading the risk associated with the consumer price protection product, the level of protection against current price, the duration or term of the protection, the market condition, the price settlement method, the manner in which the subject commodity is depleted, etc.

Each of these pricing factors may itself be divided into several categories. For example, depending upon whether the market is in contango or backwardation, the consumer price protection product may be priced differently. Backwardation describes a market where spot or prompt prices are higher than prices in the future—a downward sloping forward curve. It indicates that prompt demand is high. Contango is the opposite, with future prices higher than spot prices.

In addition to or instead of a fixed price for the consumer price protection product, the provider may offer various levels of protection and charge accordingly. The levels of protection may vary by price, volume, and/or time, and may be priced in conjunction with the market condition and/or other factors. The consumer price protection product may also be priced differently depending upon whether a pump settlement or an index-based settlement is utilized and/or whether an unrestricted or constrained depletion method is utilized. For detailed teachings on various settlement methods, including pump settlement and index-based settlement methods, as well as depletion methods, readers are directed to the above-referenced U.S. patent application Ser. No. 11/705,571, filed Feb. 12, 2007, entitled “METHOD AND SYSTEM FOR PROVIDING PRICE PROTECTION FOR COMMODITY PURCHASING THROUGH PRICE PROTECTION CONTRACTS” and Provisional Patent Application No. 60/922,427, filed Apr. 9, 2007, entitled “SYSTEM AND METHOD FOR INDEX BASEd SETTLEMENT UNDER PRICE PROTECTION,” which are incorporated herein by reference.

Although gasoline is used in examples described herein, one skilled in the art will recognize that embodiments disclosed herein can be implemented or adapted for other types of commodities. Currently, there is not a liquid trading vehicle for retail gasoline options. Wholesale gasoline options are generally traded for delivery points in New York Harbor and the Gulf Coast. From wholesale to retail, a trading entity may charge an adjustment fee based upon a readily available third party index. For example, the Department of Energy (DOE) publishes weekly a national index of retail gasoline prices in addition to several state and city indices. As one skilled in the futures trading can appreciate, volatility may also occur in this adjustment over time.

The marketability of the consumer price protection product, in some cases, depends on a provider's ability to translate a highly complex product into a simple, cohesive value proposition to its customers. A part of the marketability may also depend on striking a balance between different values and perhaps perceptions—those of the provider and those of its customers.

For example, to a consumer, the perceived value of a commodity at time of pre-purchase and the actual value of the same commodity realized at expiration of the product are important factors to consider; whereas, to the provider, ways to maximize product margins are important.

The transaction systems and data network constraints can be important in making a consumer price protection product viable to a provider of commodity price protection. In some cases, the provider may desire to minimize interchange fees. The term “interchange”, also referred to as “credit card interchange,” refers to the process by which all parties involved in a credit card transaction (i.e., processors, acquirers, issuers and so on) manage the processing, clearing and settlement of credit card transactions, including the assessment, and collection and/or distribution of fees between parties.

In some embodiments, the provider can reduce the interchange fees by issuing its own credit and/or fuel cards. Such cards may be issued in partnership with one or more financial institutions. In some cases where the subject commodity is fuel, the provider may desire to gain access to Level III pump transaction data. As one skilled in the art will appreciate, Level-1 card data is typically associated with consumer transactions and limited purchase data returned to the cardholder. Level-2 data elements benefit the corporate/government/industrial buyer and can often be transmitted via a standard credit card point of sale terminal due to their restricted capabilities. Level III pump transaction data, also known as Level-3 purchase card data with line item detail, is generally equivalent to the information found on an itemized invoice and requires greater system capability. In some embodiments, access to Level III pump transaction data may be obtained by partnering with existing fleet card providers such as WEX to utilize existing infrastructure and underwriting for fleet customers.

In some embodiments of a consumer price protection product, all option purchases and settlements are against a defined index. This is referred to herein as the index-based settlement method. Compared to the pump settlement method, the index-based settlement method has the advantage of eliminating a host of risk variables for the provider. For example, the customer may assume the economic risk if the retail price (pump price) is greater than the index price over life of the product. On the other hand, when the retail price exceeds the index price, index settled products may create or increase interchange fees. As disclosed above, to minimize the interchange fees, the provider may issue credit cards and/or providing other financial vehicles. Allowing customers to utilize other credit cards may provide desirable flexibility and hence maximize adoption, at the cost of possibly increasing interchange fees. For detailed teachings on pump settlement and index-based settlement methods, readers are directed to the above-referenced U.S. patent application Ser. No. 11/705,571, filed Feb. 12, 2007, entitled “METHOD AND SYSTEM FOR PROVIDING PRICE PROTECTION FOR COMMODITY PURCHASING THROUGH PRICE PROTECTION CONTRACTS” and Provisional Patent Application No. 60/922,427, filed Apr. 9, 2007, entitled “SYSTEM AND METHOD FOR INDEX BASED SETTLEMENT UNDER PRICE PROTECTION,” which are incorporated herein by reference.

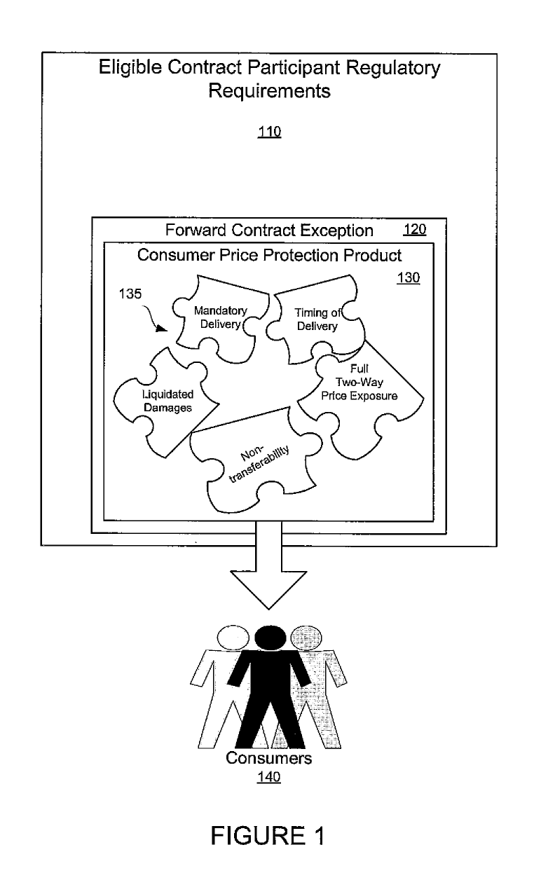

To make such a price protection product available to consumers, all regulatory requirements must be met. FIG. 1 depicts a block diagram of one embodiment of a design architecture for providing consumer price protection product 130 that meets the Eligible Contract Participant regulatory requirements 110. As exemplified in FIG. 1, forward contract exception 120 of regulatory requirements 110 may comprise a plurality of elements 135, including, but not limited to, mandatory delivery, timing of delivery, liquidated damages, non-transferability, and full two-way price exposure. In some embodiments, a method for providing a consumer price protection product to commodity consumers 140 may comprise particular steps to ensure that at least the following dimensions of the plurality of elements 135 are met:

### Mandatory Delivery

Similar to a futures contract, a consumer who purchases a consumer price protection product may be compelled to take full physical delivery of the underlying commodity before and by when the term of the contract expires. One exemplary consumer price protection product may have the following hypothetical terms: The consumer pays $1000 to the provider in exchange for the right to take delivery on 500 gallons of gasoline any time within a twelve-month period following the contract date. Absent an event of default or force majeure, delivery will then occur on one or more specified dates in the future. In this example, gasoline is the underlying commodity that the consumer seeks protection from price fluctuations during a certain time frame. Assume the agreed upon price is $2.00 per gallon of gasoline, the consumer price protection product thus allows the consumer to purchase gasoline at the agreed upon price of $2.00 per gallon, also referred to as the strike price, up to 500 gallons during the twelve-month period without being affected by any price fluctuations during the same time period.

According to a feature of the invention, both parties to a consumer price protection product are obligated to perform, are in a position to perform, and contemplate future delivery of the commodity in retail transactions. The parties do not have the right to avoid the delivery obligation by offset or similar means, whether explicit or by implication. Following the above example, the consumer can take physical delivery via installments against payment over the subsequent 12 months. The consumer may take delivery at a contract facility associated with the provider, at its discretion, when prices exceed $2.00. The contract may specify that, once the parties are in contract, the consumer cannot decline to take delivery and receive money back. If the consumer is unable to take full delivery in a timely manner (i.e., use the entire amount of the price-protected commodity within the specified contract period), embodiments described below provide additional regulatory-compliant solutions (see discussion on “Timing of Delivery” below).

### Timing of Delivery

As described above, the consumer is obliged to take delivery prior to the expiration of the terms of the contract as specified in the consumer price protection product. However, in some cases, there may be an unused portion at the end of the contract period. For example, assume that on the 365^{th} day of the aforementioned contract, the consumer has taken delivery of 400 gallons of gasoline and has yet to take delivery of the final 100-gallon installment. According to an aspect of the invention, several regulatory-compliant solutions may be made available to the consumer (see further discussion below on “Full Two Way Price Exposure”).

### Liquidated Damages

Upon the expiration of each contract where a consumer has not taken physical delivery in full of the amount agreed to, in some embodiments, the consumer may roll into a new specific contract with a specific termination date and mandatory delivery period, subject to the provider's agreement, or pay the provider liquidated damages. If the provider permits the consumer to roll into a new contract, the provider incurs additional economic risk for this new period and must lay off this risk at a price to its hedging partner(s) and charge the consumer for this roll-forward privilege. It is necessary to compensate the provider for the additional economic risk incurred because the contract could otherwise be characterized as a call option, thus no longer meets the forward contract exception of the regulatory requirements. Again, if the consumer fails to take physical delivery in breach of the contract's terms, the measure of the performing party's damages is its cost of cover, i.e., the difference between the agreed upon contract price and the then current market price which, in this case, would be the hedging cost incurred by the provider to extend the delivery date to the newly specified contract termination date.

### Non-Transferability

The consumer price protection contract is not transferable or assignable without the consent of the provider and transfers or assignments are not expected to occur, except by operation of law. The consumer must take physical delivery during the contract period or roll-over to a new contract at the expiration of the existing contract, pursuant to a subsequent agreement with the provider, or lose or forfeit the money invested in the contract position and make the provider whole, i.e., compensate the provider for its cost of cover. Embodiments of the consumer price protection product disclosed herein are not a vehicle for the consumer to speculate on price movements without incurring the obligation to take delivery of the commodity. The consumer cannot market the consumer price protection contract.

### Full Two-Way Price Exposure

In a consumer price protection forward contract, no limit can be placed on the upward price insurance that the provider offers to the consumer. For example, the provider cannot specify that the consumer is only protected from price increases from $2.00 to $3.00 and thus exclude price protection from adverse movements over $3.00. Such a limited upside coverage would create the incidents of a call option and will not be allowed. Under the consumer price protection contract, the provider and the consumer are each fully exposed to the risk of adverse price movements in the underlying commodity and is at risk for more than a specified, predetermined amount pursuant to the terms of the contract. The consumer thus can have unlimited downside risk.

In cases where there is a balance at the end of the contract, embodiments of the invention provide several regulatory-compliant solutions, including:

Solution 1: returning the unused portion to the consumer in the form of cash, check, and/or credit;

Solution 2: allowing the consumer to rollover the unused portion to a new consumer price protection contract;

Solution 3: allowing the consumer to take physical delivery at the then prevailing retail price, even after the expiration date of the contract; and

Solution 4: allowing the consumer to take physical delivery within a range of prices, even after the expiration date of the contract.

Following the above example, with Solution 1, the consumer may get money back on the 100 gallons of gasoline at $2.00 per gallon. A processing fee may or may not be assessed in conjunction with Solution 1.

With Solution 2, the consumer may, for a nominal fee, rollover the 100 gallons of gasoline to a new consumer price protection product (i.e., a subsequent agreement), which may have different terms. In other words, both parties may agree to extend the delivery terms on the remaining 100 gallons after the original contract expiration date, pursuant to a new contract. The probable cost of such an extension may be some portion or all of the cost the provider incurs to extend the insurance into the new future period through the acquisition of additional economic risk insurance through a hedging partner such as a financial institution. For the purpose of illustration, assume the provider and the consumer agree to roll the contract forward for another year and that the provider roll-over fee would be twenty (20) cents per gallon or $20.00 for 100 gallons. In the futures industry vernacular, such a fee would be known as a “Cover”. Here, it can be considered as an “extension fee”.

Although the parties may subsequently agree yet again to roll the delivery date(s) forward, delivery may not be rolled indefinitely on any single contract. So long as each contract has a defined time and terms, there can be unlimited number of rollovers. In one embodiment, a consumer price protection product may specify that only one rollover is allowed.

In some embodiments, there can be no time period in between two contracts (i.e., the original contract and the new contract with the rollover). Although no inter-contract period is allowed, an intra-contract grace period may be possible so as to give the consumer time to consider available choices and make decisions accordingly.

Solution 3 allows the consumer to take physical delivery at post contract spot price, which is the then prevailing retail price. With Solution 3, the consumer must take delivery at the pump per the agreed restriction. That is, the original contract may specify that, for post contract delivery under Solution 3, the consumer is restricted by the dollar value representing the unused portion, by the volume representing the unused portion, or the like. Following the above example, the consumer may be restricted to buying $200 worth of gasoline at the pump via a credit card associated with the consumer price protection product. During the contract period, $200 can buy 100 gallons of gasoline. If the same type and grade of fuel now costs $2.50 per gallon at the pump, the consumer ends up with 80 gallons of gasoline through post contract delivery.

On the other hand, if the same type and grade of fuel now costs $1.50 per gallon at the pump, the post contract delivery solution with dollar-restriction allows the consumer to buy 133 gallons of gasoline. If the consumer price protection product specifies that the consumer is gallon-restriction, the consumer can buy 100 gallon of gasoline at the agreed price (strike price), regardless of the retail price at the pump. As the strike price is fixed, this solution may provide the consumer some fixed price protection for a limited time even after the contract period.

With Solution 4, a consumer price protection product can be seen as a range forward contract where the strike price is variable with a finite ceiling and floor. Instead of having a discrete strike price, the consumer can take forward delivery within a range of strike prices. This solution provides a consumer range protection and the consumer cannot use it outside of the specified range, reducing optionality. For example, suppose the consumer price protection product specifies that the strike price ceiling is $2.50 and the strike price floor is $1.00. The consumer is protected over this range and never pays more than $2.50 or less than $1.00. The consumer may be given a fuel card or some form of fuel credit with which the consumer can purchase fuel at the pump. After the contract ends, the consumer can still use the remainder on the card to buy fuel at the pump so long as the pump price is within that same range defined by the ceiling and the floor. The consumer can not use the card or credit if the pump price is outside of the defined range of strike prices.

### Not Fully Standardized

The consumer price protection contract allows the consumer discretion as to time and location of physical delivery. The terms of the contract between the parties are not fully standardized or fungible. Every consumer price protection contract is thus different.

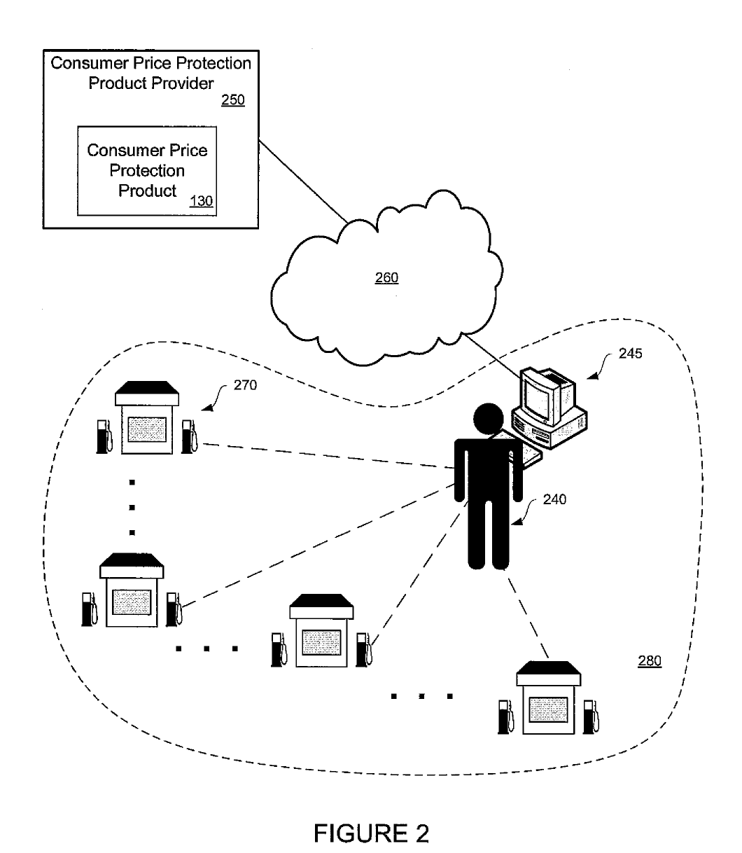

FIG. 2 depicts a block diagram of one embodiment of a system architecture for providing a Web-based consumer price protection product over a network. As an example, a consumer price protection product provider may maintain a server computer hosting Website or portal 250 through which various types of consumer price protection product 130 may be purchased by consumer 240 over network 260 using computer 245. In some embodiments, network 260 may comprise the Internet. Consumer 240 may direct a browser application running on computer 245 to a particular network address serviced by Website 250 that offers consumer price protection product 130. Transaction systems and commercial entities associated with Website 250 are not shown in FIG. 2 for the sake of clarity. As an example, consumer 240 may desire to purchase gasoline within geographic boundary 280 having a plurality of stations 270. Computer 245 may or may not be within geographic boundary 280. Thus, consumer 240 may purchase consumer price protection product 130 from just about anywhere in the world and be protected in geographic boundary 280 so long as computer 245 can communicate with Website 250.

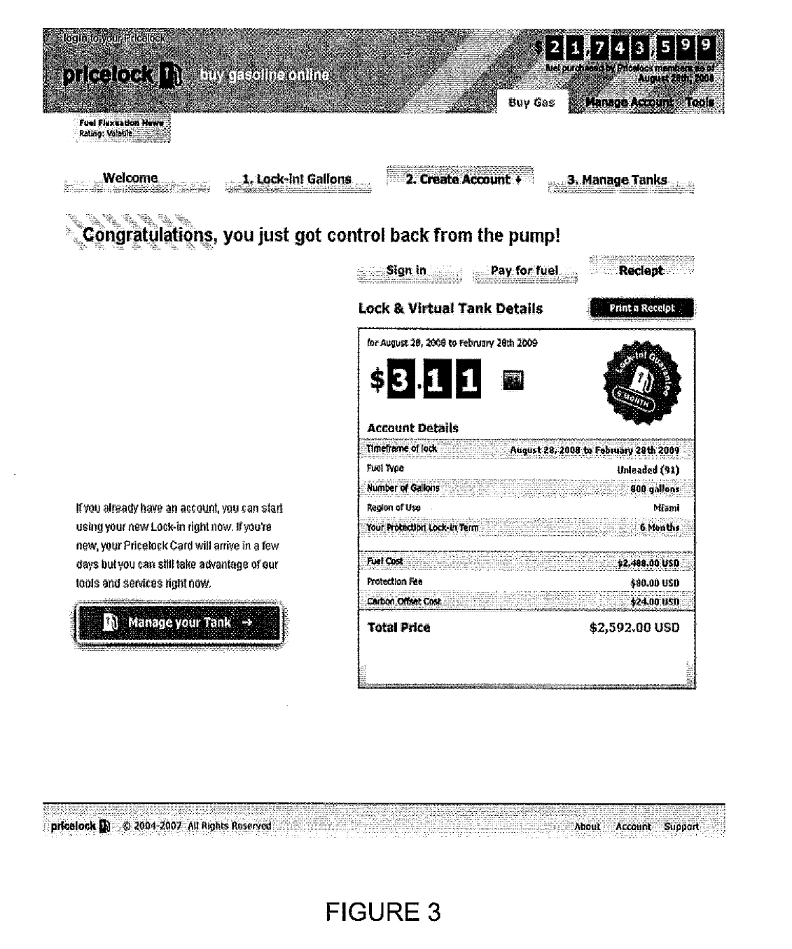

FIG. 3 is a screenshot of one embodiment of a user interface of a Web-based application through which a consumer price protection product that meets the Eligible Contract Participant regulatory requirements may be purchased over the Internet. A sample consumer price protection product can be found in the accompanying Appendix A attached to this disclosure. In the example of FIG. 3, a consumer purchased a consumer price protection product for price protection over a period of six months for 800 gallons of 91 unleaded gasoline in the city of Miami. The protection fee is 10 cents per gallon and the consumer locks in at $3.11 per gallon. The carbon offset is provided to the consumer as a purchase choice. As discussed above, motor fuels may generally be classified based in part on sulfur content and emission credits may generally be classified based on sulfur or carbon content, etc. Thus, each type of fuel may have a corresponding amount of emission credits associated therewith. In some embodiments, emission credits for a particular grade of motor fuel are determined based on the carbon content of that particular fuel. The consumer may choose to buy carbon credits to offset the amount of fuel consumed. In this example, the carbon offset fee is three cents per gallon.

Through Website 250, the provider may provide a plurality of online tools and functions to the consumer. For example, a virtual tank function may operate to allow the consumer to monitors and tracks the usage of the 800 gallons of gasoline in the specified period. A real-time function, which may be linked to the consumer's global positioning system enabled device, may operate to provide the consumer with a map and suggestions as to where to buy gas and how much the consumer might be saving at a certain location. Examples of such online tools can be found in co-pending U.S. patent application Ser. No. (Attorney Docket No. PRICE1130-1), filed Feb. ______, 2008, entitled “MANAGEMENT AND DECISION MAKING TOOL FOR COMMODITY PURCHASES WITH HEDGING SCENARIOS,” which is incorporated herein by reference. Other implementations of Website 250 are also possible.

In addition to commodity-related regulatory requirements, embodiments of a retail consumer price protection product disclosed herein may also comply with accounting-related regulatory requirements. Examples of accounting-related regulations include standards established by the Financial Accounting Standards Board (FASB). The FASB is the designated organization in the private sector for establishing standards of financial accounting and reporting. Standards established by the FASB, which include Statement of Financial Accounting Standards Number 133 Accounting for Derivatives and Hedge Accounting as amended (FAS 133), are officially recognized as authoritative by the Securities and Exchange Commission (SEC). FAS 133 requires all derivatives to be recorded on the balance sheet at fair value and establishes special (or hedge) accounting for three different types of hedges, one of which is referred to as cash flow hedges. Cash Flow hedges offset the variable cash flows associated with assets, liabilities, or forecasted transactions (the remaining two types of hedges, fair value and net investment hedges will not be discussed in this document). Though the accounting treatment and criteria for hedge accounting is unique, hedge accounting seeks to recognize the effective portion of gains or losses from the hedging instrument and the hedged item in earnings in the same period. Gains and losses that are not effective in a hedging relationship are recorded in income immediately. Changes in the fair value of derivatives that do not meet the hedge accounting criteria are also recorded immediately in income.

FAS 133 treats hedge accounting as a privilege a company must qualify to use, with a default to fair value accounting (all changes in fair value of derivatives directly reflected in earnings) when those qualifications are not met. Under the FAS 133, hedge relationships must meet extensive documentation requirements, and hedge effectiveness (a mathematical representation of how well the product off-sets the exposure) must be assessed and hedge ineffectiveness (the amount the changes in the market value of the hedge exceeded those of the exposure) measured on a continuous basis. Hedge relationships which are highly effective may qualify for special hedge accounting, but special hedge accounting requires that the elements of the hedge relationship which are not perfectly effective be recorded in the financial statements as hedge ineffectiveness. Accordingly, extensive system support may be needed to assist in meeting all the requirements.

FAS 133 defines derivatives based on their characteristics, rather than just listing certain instruments commonly thought of as derivatives. Continued innovations in the financial markets would render any definition based on listings of particular instruments as obsolete. As a result, FAS 133 definition of a derivative could differ in certain instances from what many market participants consider to be “derivatives.” Most instruments commonly thought of as derivatives will meet FAS 133's broad definition. These instruments include options and forward contracts. Certain items such as some commodity purchase and sale agreements (including those entered into by commercial companies), will also, in whole or in part, meet FAS 133's definition of a derivative.

As discussed above, the default accounting for derivative instruments is fair value accounting. That is, derivatives are recorded in the balance sheet at fair value and changes in the fair value from period to period are recorded in the income statement. However, if a derivative is utilized as a risk management instrument in order to lock in future prices then the FAS 133 special hedge accounting provisions may be utilized. Specifically, “special” hedge accounting can only be obtained for items or transactions that meet certain criteria provided by FAS 133. To qualify as cash flow hedge, the hedge relationship must meet criteria relating both to the derivative instrument and the hedged item. The most significant criteria are as follows:

At inception of the hedge, there is formal documentation of the hedging relationship and the entity's risk management objective and strategy for undertaking the hedge, including identification of the hedging instrument, the hedged item, the nature of the risk being hedged, and how the hedging instrument's effectiveness in offsetting the exposure to changes in the hedged item's cash flows will be assessed (i.e., measured).

Both at inception of the hedge and on an ongoing basis, the hedging relationship is expected to be highly effective in achieving offsetting changes in cash flows during the period that the hedge is designated. While not specifically identified by FAS 133, standard industry practices have determined “highly effective” means that the hedge offsets the changes in the cash flows of the hedged item with an 80 to 125% range. This criterion means that the transaction must be probable of occurring. Although FAS 133 provides flexibility in determining how to assess the effectiveness of a hedging relationship, an assessment is required whenever financial statements or earnings are reported, and at least every three months. The most common method of assessing effectiveness is simple linear regression.

The hedged item presents an exposure to change in cash flows that could affect reported earnings. Thus, inter-company dividends and equity transactions cannot be hedged.

Embodiments of a retail consumer price protection product disclosed herein meet the definition of a derivative and include the following characteristics:

### Underlying

In embodiments where a consumer price protection contract is offered either at a strike or at a fixed pump price, the value of the contract is driven by the difference between the prevailing pump price and the fixed (or strike) price. As such, the underlying is defined as the pump price.

### Notional

In embodiments where the commodity is a specific type of motor fuel, each consumer price protection contract references a specific number of gallons of fuel to be purchased under the contract. The number of gallons when multiplied by the underlying determines final settlement value of the contract, thus meeting the definition of a notional.

### No Initial Net Investment

FAS 133 requires that the amount invested in a contract be less, by more than a nominal amount, than the initial net investment that would be commensurate with the amount that would be required to acquire the fuel at the pump. As the premium paid by the customer is expected to be less than the total notional value of the contract, each embodiment of a retail consumer price protection product disclosed herein is more than likely to meet the definition of no initial net investment.

### Net Settlement

In embodiments disclosed herein, the term “settlement” refers to a financial settlement, which is the difference between the pump price and the contract (agreed) price. As an example, a consumer may purchase fuel and be billed by a fuel card company. The purchase may appear as a credit or debit on the bill. In no circumstance will the fuel be physically delivered to the consumer. This meets the definition of net settlement per FAS 133 as “neither party is required to deliver an asset that is associated with the underlying.”

Even though embodiments disclosed herein would meet the definition of a derivative and could potentially be used in a cash flow hedge, each customer designating the hedge must maintain and update quarterly the appropriate documentation of the hedge relationship, as required by FAS 133, in order to qualify for hedge accounting. If the customer fails to meet the document requirements per FAS 133, the customer could be prevented from applying hedge accounting, even if the contract can be used as a cash flow hedge.

In the foregoing specification, the invention has been described with reference to specific embodiments. However, one of ordinary skill in the art will appreciate that various modifications and changes can be made without departing from the spirit and scope of the invention disclosed herein. Accordingly, the specification and figures disclosed herein are to be regarded in an illustrative rather than a restrictive sense, and all such modifications are intended to be included within the scope of the following claims and their legal equivalents.

What is claimed is:

1. A method for providing commodity price protection to individual consumers, comprising:
requiring a consumer to pay a provider an amount in exchange for a right to take physical delivery on a quantity of a commodity at an agreed price per unit of the commodity at any time within a specified period without being affected by price fluctuations associated with the commodity during the specified period, wherein the specified period ends at an expiration date;
exposing the provider to unlimited upward risk of the price fluctuations associated with the commodity during the specified period;
exposing the consumer to unlimited downside risk of the price fluctuations associated with the commodity during the specified period;
specifying that the right to take the physical delivery on the quantity of the commodity at the agreed price per unit of the commodity at any time within the specified period is not transferable, assignable, or marketable;
requiring the consumer to take the physical delivery of the quantity of the commodity before and by the expiration date;
allowing the consumer discretion as to time and location of the physical delivery; and
where the consumer has not taken the physical delivery of the quantity of the commodity upon the expiration date, providing the consumer with a plurality of regulatory-compliant solutions.

2. The method of claim 1, wherein the plurality of regulatory-compliant solutions comprises returning an unused portion of the quantity of the commodity to the consumer in the form of cash, check, credit, or a combination thereof.

3. The method of claim 1, wherein the plurality of regulatory-compliant solutions comprises allowing the consumer to rollover an unused portion of the quantity of the commodity to a new consumer price protection contract with a specific termination date and mandatory delivery period.

4. The method of claim 3, further comprising specifying that only one rollover is allowed.

5. The method of claim 3, further comprising specifying that no inter-contract period is allowed.

6. The method of claim 1, wherein the plurality of regulatory-compliant solutions comprises requiring the consumer to pay liquidated damages.

7. The method of claim 1, wherein the plurality of regulatory-compliant solutions comprises allowing the consumer to take delivery of an unused portion of the quantity of the commodity at a retail price of the commodity, even after the expiration date.

8. The method of claim 1, wherein the plurality of regulatory-compliant solutions comprises allowing the consumer to take delivery of an unused portion of the quantity of the commodity within a range of agreed prices, even after the expiration date.

9. The method of claim 1, further comprising allowing the consumer to pay the provider over a network and monitor a usage of the quantity of the commodity via a Website maintained by the provider.

10. A computer-readable storage medium carrying program instructions executable by a processor to:
enable a consumer to pay a provider an amount in exchange for a right specified in a consumer price protection contract to take physical delivery on a quantity of a commodity at an agreed price per unit of the commodity at any time within a specified period without being affected by price fluctuations associated with the commodity during the specified period, wherein the specified period ends at an expiration date, wherein the consumer price protection contract exposes the provider to unlimited upward risk of the price fluctuations associated with the commodity during the specified period, wherein the consumer price protection contract exposes the consumer to unlimited downside risk of the price fluctuations associated with the commodity during the specified period, wherein the consumer price protection contract specifies that the right to take the physical delivery on the quantity of the commodity at the agreed price per unit of the commodity at any time within the specified period is not transferable, assignable, or marketable, wherein the consumer price protection contract requires the consumer to take the physical delivery of the quantity of the commodity before and by the expiration date, and wherein the consumer price protection contract allows the consumer discretion as to time and location of the physical delivery;
allow the consumer to monitor a usage of the quantity of the commodity via a Website maintained by the provider; and
provide the consumer with a plurality of regulatory-compliant solutions via the Website where the consumer has not taken the physical delivery of the quantity of the commodity upon the expiration date.

11. The computer-readable storage medium of claim 10, wherein the plurality of regulatory-compliant solutions comprises returning an unused portion of the quantity of the commodity to the consumer in the form of cash, check, credit, or a combination thereof.

12. The computer-readable storage medium of claim 10, wherein the plurality of regulatory-compliant solutions comprises allowing the consumer to rollover an unused portion of the quantity of the commodity to a new consumer price protection contract with a specific termination date and mandatory delivery period.

13. The computer-readable storage medium of claim 10, wherein the plurality of regulatory-compliant solutions comprises requiring the consumer to pay liquidated damages.

14. The computer-readable storage medium of claim 10, wherein the plurality of regulatory-compliant solutions comprises allowing the consumer to take delivery of an unused portion of the quantity of the commodity at a retail price of the commodity, even after the expiration date.

15. The computer-readable storage medium of claim 10, wherein the plurality of regulatory-compliant solutions comprises allowing the consumer to take delivery of an unused portion of the quantity of the commodity within a range of agreed prices, even after the expiration date.

16. A system for providing commodity price protection to individual consumers, comprising:
a processor;
a computer-readable storage medium accessible by the processor and carrying program instructions executable by the processor to:
enable a consumer to pay a provider an amount in exchange for a right specified in a consumer price protection contract to take physical delivery on a quantity of a commodity at an agreed price per unit of the commodity at any time within a specified period without being affected by price fluctuations associated with the commodity during the specified period, wherein the specified period ends at an expiration date, wherein the consumer price protection contract exposes the provider to unlimited upward risk of the price fluctuations associated with the commodity during the specified period, wherein the consumer price protection contract exposes the consumer to unlimited downside risk of the price fluctuations associated with the commodity during the specified period, wherein the consumer price protection contract specifies that the right to take the physical delivery on the quantity of the commodity at the agreed price per unit of the commodity at any time within the specified period is not transferable, assignable, or marketable, wherein the consumer price protection contract requires the consumer to take the physical delivery of the quantity of the commodity before and by the expiration date, and wherein the consumer price protection contract allows the consumer discretion as to time and location of the physical delivery;
allow the consumer to monitor a usage of the quantity of the commodity via a Website maintained by the provider; and
provide the consumer with a plurality of regulatory-compliant solutions via the Website where the consumer has not taken the physical delivery of the quantity of the commodity upon the expiration date.

17. The system of claim 16, wherein the plurality of regulatory-compliant solutions comprises returning an unused portion of the quantity of the commodity to the consumer in the form of cash, check, credit, or a combination thereof.

18. The system of claim 16, wherein the plurality of regulatory-compliant solutions comprises allowing the consumer to rollover an unused portion of the quantity of the commodity to a new consumer price protection contract with a specific termination date and mandatory delivery period.

19. The system of claim 16, wherein the plurality of regulatory-compliant solutions comprises requiring the consumer to pay liquidated damages.

20. The system of claim 16, wherein the plurality of regulatory-compliant solutions comprises allowing the consumer to take delivery of an unused portion of the quantity of the commodity at a retail price of the commodity or within a range of agreed prices, even after the expiration date.

21. The system of claim 16, wherein the plurality of regulatory-compliant solutions is in compliant with commodity-related regulatory requirements set forth by the Commodity Futures Trading Commission (CFTC).

22. The system of claim 21, wherein the plurality of regulatory-compliant solutions is in compliant with accounting standards established by the Financial Accounting Standards Board (FASB).
